(19) United States
(12) Patent Application Publication
(10) Pub. No.: US 2011/0169311 A1
(43) Pub. Date: Jul. 14, 2011

(54) Headrest Assembly

(75) Inventors: Michael Powell, Waterford, MI (US); Karl Henn, New Hudson, MI (US); Daniel Arico, New Baltimore, MI (US)

(73) Assignee: LEAR CORPORATION, Southfield, MI (US)

(21) Appl. No.: 13/120,754

(22) PCT Filed: Oct. 31, 2008
(86) PCT No.: PCT/US08/81906

§ 371 Date: Mar. 24, 2011

(51) Int. Cl. B60N 2/20; B60N 2/22; B60N 2/48; A47C 7/36; B60N 2/68

(52) U.S. Cl. 297/354.1

(57) ABSTRACT

A vehicle seat frame assembly 10 includes a seat bottom frame 14 and a seat back frame 12 pivotally mounted relative to the seat bottom frame 14. A headrest assembly 47 has a headrest 76 and is movable between an extended position and a retracted position relative to the seat back frame 12. The headrest assembly 47 is pivotally connected to the one of the seat bottom frame 14 and a portion of the vehicle, and slidingly connected to the seat back frame 12.

### BACKGROUND

Various embodiments of a vehicle seat frame assembly are described herein. In particular, the embodiments described herein relate to an improved headrest assembly for a vehicle seat frame assembly.

It is known to equip vehicles, such as vans and sport utility vehicles, with second or third row seats that can be moved from a use position to a stowed position to increase storage space in the vehicle. In such seat assemblies, the fold-down seat back is pivotally mounted at its lower end to the seat base for rotation between the use position, typically an upright position, and the stowed position, which typically involves the seat back folding to a position approximately parallel to the seat base.

It is also known to provide a headrest that moves inward of the seat back when the seat back is pivoted toward the stowed position, and moves outward of the seat back when the seat back is pivoted toward the use or upright position. Such headrests are typically moved manually or with complicated and costly power mechanisms.

One example of a known headrest assembly is disclosed in U.S. Pat. No. 7,140,687, wherein springs 70 are coupled to gears 84 for moving the headrest 14 between a use position and a stow position.

U.S. Pat. No. 6,192,565 discloses a seat assembly having a retractable headrest 24. The assembly includes a headrest assembly 24 biased into the use position by springs 36 mounted on guideposts 42. A cable 52 is mounted to the bottom of the seat back 20 and a lever 46. The lever 46 is attached to the headrest assembly 24. When the seat back 20 is pivoted toward the stowed position, the cable 52 pulls the lever 46, which moves the headrest assembly 24 against the force of the springs 36 and toward the stowed position.

U.S. Pat. No. 6,726,283 discloses a gear driven actuator for a retractable headrest. A sun gear 38 is fixed against rotation relative to the vehicle, and a planet gear 40 is attached to the seat back frame 12 and rotatably engaged with the sun gear 38. The planet gear 40 is operatively engaged with the headrest 22 to extend and retract the headrest 22 as the planet gear 40 rotates the sun gear 38.

### SUMMARY

The present application describes various embodiments of a vehicle seat frame assembly. One embodiment of the vehicle seat frame assembly includes a seat bottom frame and a seat back frame pivotally mounted relative to the seat bottom frame. A headrest assembly has a headrest and is movable between an extended position and a retracted position relative to the seat back frame. The headrest assembly is pivotally connected to the one of the seat bottom frame and a portion of the vehicle, and slidingly connected to the seat back frame.

Other advantages of the vehicle seat frame assembly will become apparent to those skilled in the art from the following detailed description, when read in light of the accompanying drawings.

### BRIEF DESCRIPTION OF THE DRAWINGS

FIG. 1 is a rear elevation view of a vehicle seat frame having a first embodiment of a headrest assembly.

FIG. 2 is a front perspective view of the headrest assembly illustrated in FIG. 1, with portions of the seat frame omitted for ease of illustration.

FIG. 3 is a front perspective view of the headrest assembly and the seat back frame illustrated in FIG. 1.

FIG. 4 is a side elevation view of the vehicle seat frame and headrest assembly illustrated in FIG. 1, showing the seat back frame in an upright position.

FIG. 5 is an enlarged side elevation view, partially in cross-section, of a portion of the vehicle seat frame and headrest assembly illustrated in FIG. 4.

FIG. 6 is a side elevation view of the vehicle seat frame and headrest assembly illustrated in FIG. 4, showing the seat back frame in an intermediate position.

FIG. 7 is a side elevation view of a portion of the vehicle seat frame and headrest assembly illustrated in FIGS. 4 and 6, showing the seat back frame in a forward folded position.

FIG. 8 is a top perspective view of the vehicle seat frame and headrest assembly illustrated in FIG. 7, showing the seat back frame in the forward folded position.

### DETAILED DESCRIPTION

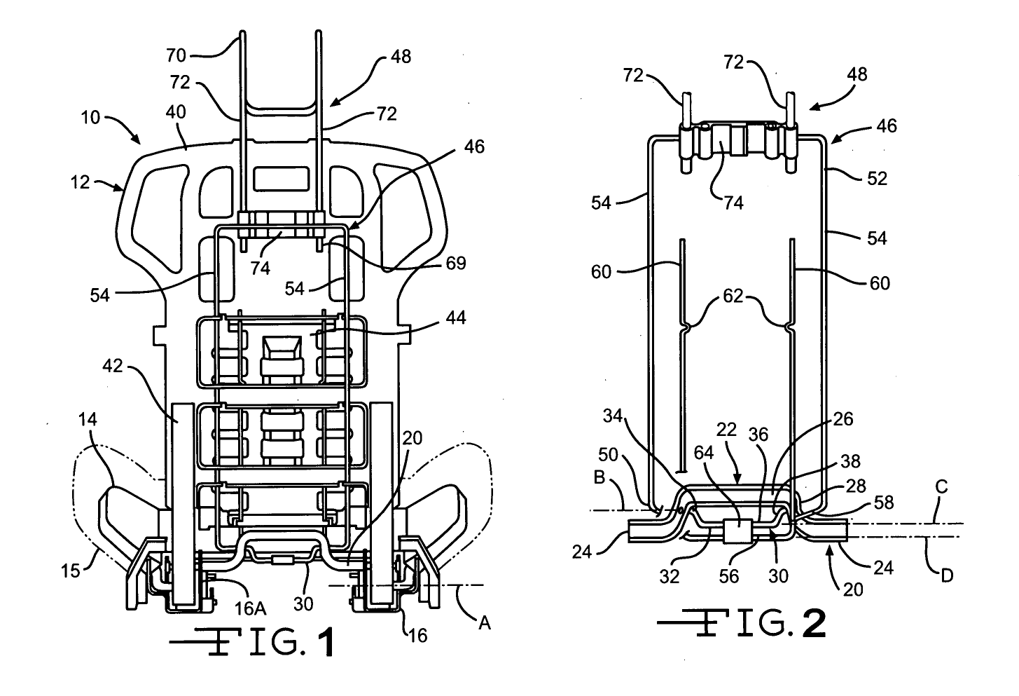

Referring now to the drawings, there is illustrated in FIG. 1a vehicle seat frame assembly, indicated generally at 10. The seat frame assembly 10 includes a seat back frame 12 and a seat bottom frame, indicated generally at 14. To form a completed vehicle seat, the frames 12 and 14 are covered with padding (not shown on the seat back 12, but shown by the phantom line 15 on the seat bottom 14) and an outer trim cover layer (not shown). The seat back frame 12 is pivotally mounted to the seat bottom frame 14 about a pivot axis A. The seat back frame 12 may be pivotally mounted to the seat bottom frame 14 via a recliner mechanism (not shown) for adjusting the seat back frame 12 to a desired inclined angle relative to the seat bottom frame 14. The recliner mechanism may be operated manually by a handle (not shown) or may include a motor drive unit (not shown) for electric operation.

The seat frame assembly 10 further includes a mounting frame assembly, a portion of which is shown at 16, which mounts the seat bottom frame 14 to the floor 18 of the vehicle in which the seat frame assembly 10 is installed. Such a mounting frame assembly may be configured to move the seat frame assembly 10 in fore and aft directions, as well as in a generally vertical direction.

As best shown in FIGS. 1 and 2, the seat bottom frame 14 includes an attachment bracket 20. The attachment bracket 20 is attached to sides 16A of the mounting frame assembly 16. In the illustrated embodiment, the attachment bracket 20 is welded to the seat bottom frame 14. It will be understood however, that the attachment bracket 20 may be attached to the seat bottom frame 14 by any suitable means.

The illustrated attachment bracket 20 has a substantially U-shaped central portion 22. Attachment portions 24 extend outwardly of the U-shaped central portion 22 (to the left and right, respectively, when viewing FIG. 2), the distal ends of which are attached to the seat bottom frame 14. The U-shaped central portion 22 includes a first portion 26 and two side members 28 extending substantially transversely between the first portion 26 and the attachment portions 24. Alternatively, attachment bracket 20 may be attached to the vehicle frame, such as the vehicle floor 18.

In the illustrated embodiment, a bell crank 30 is attached to the side members 28 of the U-shaped central portion 22 of the attachment bracket 20. The illustrated bell crank 30 is pivotally attached to the side members 28 about a pivot axis B, for purposes that are described in detail below.

The illustrated bell crank 30 has a substantially U-shaped central portion 32. Attachment portions 34 extend outwardly of the U-shaped portion 32 (to the left and right, respectively, when viewing FIG. 2), the distal ends of which are pivotally attached to the attachment bracket 20. The U-shaped central portion 32 includes a first portion 36 and two side members 38 extending substantially transversely between the first portion 36 and the attachment portions 34.

The illustrated seat back frame 12 is formed having a one-piece body 40. It will be understood however, that the seat back frame 12 may alternatively be formed from a plurality of component frame members. The illustrated seat back frame 12 includes side frame members 42 and the body 40. In the illustrated embodiment, the side frame members 42 are pivotally attached to the seat bottom frame 14 at the pivot axis A.

The seat back frame 12 may further include a lumbar support member 44. The lumbar support member 44 may be attached to the seat back frame 12 by any suitable method, such as for example, by welding, rivets, and threaded fasteners. It will be understood that the lumbar support member 44 may be attached to the body 40 by any other desired method.

A headrest assembly frame 46 is operably attached between the seat bottom frame 14, the seat back frame 12, and a headrest bracket 48. The illustrated headrest assembly frame 46 is formed from a substantially cylindrical and rigid material. One example of a suitable material is steel. Alternatively, the headrest assembly frame 46 may be formed from aluminum. The illustrated headrest assembly frame 46 has a first end 50 (lower end when viewing FIG. 2), a second end 52 (upper end when viewing FIG. 2), and substantially parallel elongated headrest push rods 54 extending between the first and second ends 50 and 52.

The illustrated first end 50 is stepped to define a U-shaped portion 56. The push rods 54 at the first end 50 of the headrest assembly frame 46 include an inwardly and forwardly extending (when viewing FIG. 4) portion 58 extending between the push rods 54 and the U-shaped portion 56. Two substantially parallel lumbar push rods 60 extend upwardly (when viewing FIG. 2) from the U-shaped portion 56. The illustrated embodiment of the lumbar push rods 60 includes an inwardly extending (when viewing FIG. 2) substantially C-shaped protrusion or boss 62 for engaging and attaching to the lumbar support member 44.

A linkage 64 is pivotally attached to the first portion 36 of the bell crank 30 about a first linkage pivot axis C, and pivotally attached to the first end 50 of the headrest assembly frame 46 about a second linkage pivot axis D. The illustrated linkage 64 includes substantially flat and parallel first and second faces 66. Pivot grooves 68 are defined between the two faces 66 and are structured and configured for receiving the first portion 36 of the bell crank 30 and the first end 50 of the headrest assembly frame 46. The illustrated linkage 64 is formed from a substantially rigid material. One example of a suitable material is steel. Alternatively, the linkage 64 may be formed from aluminum.

As best shown in FIG. 1, the attachment bracket 20, the bell crank 30, the linkage 64, the headrest assembly frame 46, and the headrest bracket 48 define a headrest assembly 47.

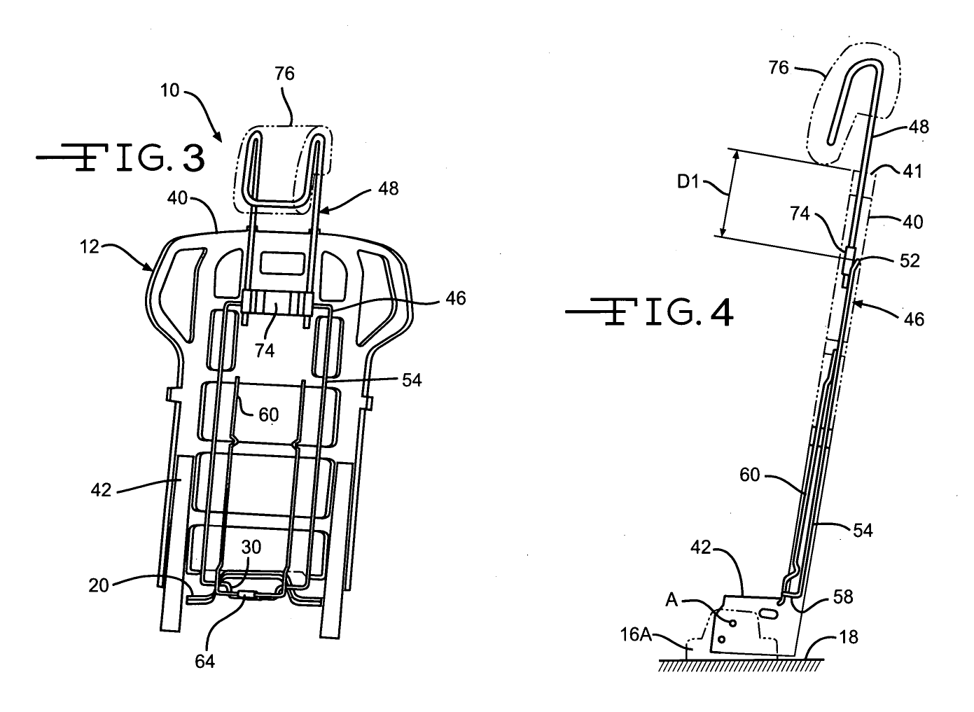

The illustrated headrest bracket 48 is formed from a substantially cylindrical and rigid material. One example of a suitable material is steel, such as a steel rod. Alternatively, the headrest bracket 48 may be formed from steel tubing. It will be understood that the bracket 48 may also be formed from any other desired and substantially rigid metal, metal alloy, or non-metal. The illustrated headrest bracket 48 has a first end 69 (lower end when viewing FIG. 1), a second end 70 (upper end when viewing FIG. 1), and substantially parallel elongated headrest rods 72 extending between the first and second ends 69 and 70. The second end 70 may be provided with a headrest, as shown by the phantom line 76 in FIGS. 3, 4, and 7.

In the illustrated embodiment, the headrest rods 72 are fixedly connected to the headrest assembly frame 46 by an attachment member 74. In the illustrated embodiment, the attachment member 74 is an over-molded plastic member. It will be understood however, that the headrest rods 72 may be connected to the headrest assembly frame 46 by any desired method including welding, fasteners such as threaded fasteners, or other plastic and non-plastic attachment brackets. The illustrated headrest bracket 48 is shown with two headrest rods 72. It will be understood however, that the headrest bracket 48 may be constructed having one or more than two 2 headrest rods 72.

The illustrated headrest assembly frame 46 includes two substantially parallel elongated headrest push rods 54 extending between the first and second ends 50 and 52 of the frame 46. It will be understood however, that any desired number of push rods 54 may be provided, including one push rod 54, and more than two push rods 54.

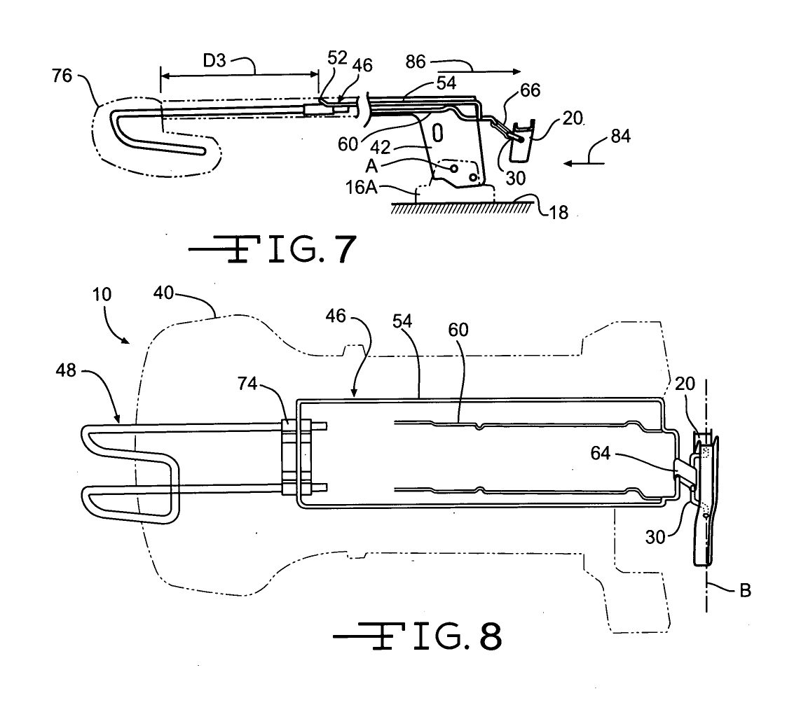

In operation, the seat back frame 12 may be moved, relative to the seat bottom frame 14, between an upright position as shown in FIG. 4, through a plurality of intermediate positions, one of which is shown in FIG. 6, and a forward folded position, as shown in FIG. 7.

As best shown in FIG. 4, when the seat back frame 14 is in the upright position, the headrest assembly frame 46 is in the extended position. In the extended position, the second end 52 of the headrest assembly frame 46 is at a minimum distance D1 relative to a first end 41 (upper end when viewing FIG. 4) of the seat back frame body 40.

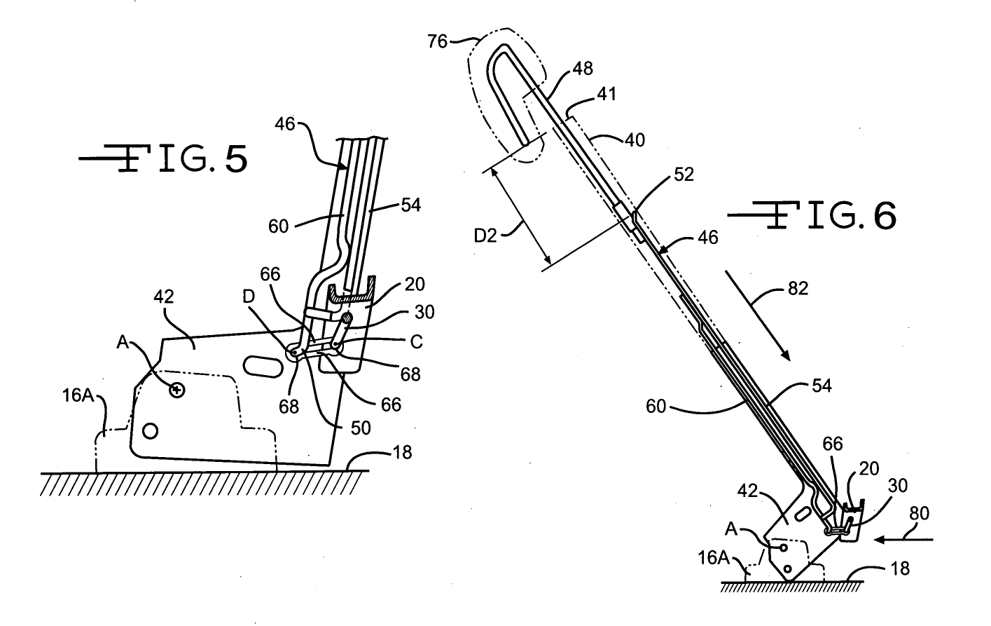

When the seat back frame 14 is in the upright position as shown in FIGS. 4 and 5, the linkage 64 is substantially horizontal (when viewing FIG. 5) and pivotally attached to the first portion 36 of the bell crank 30 about the first linkage pivot axis C, and pivotally attached to the first end 50 of the headrest assembly frame 46 about the second linkage pivot axis D, thereby defining a first position of the headrest assembly 47.

As best shown in FIG. 6, when the seat back frame 14 is in an intermediate position, the headrest assembly 47 is in an intermediate position. In an intermediate position, the bell crank 30 pivots relative to both the attachment bracket 20 and the linkage 64, such that the bell crank pivots about the axis A in a clockwise direction and the attachment bracket 20 moves in the direction of the arrow 80 (to the left when viewing FIG. 6). The linkage 64 and the bell crank 30 allow for limited movement of the headrest assembly frame 46 (in the direction of the arrow 82 relative to the seat back frame body 40), such that the second end 52 of the headrest assembly frame 46 is at an intermediate distance D2, greater than the distance D1, relative to the first end 41 (upper end when viewing FIG. 6) of the seat back frame body 40.

As best shown in FIG. 7, when the seat back frame 14 is in the forward folded position, the headrest assembly frame 46 is in the retracted position. In the retracted position, the second end 52 of the headrest assembly frame 46 is at a maximum distance D3, greater than the distances D1 and D2, relative to the first end 41 (left most end when viewing FIG. 7) of the seat back frame body 40.

When the seat back frame 14 is in the forward folded position, the headrest assembly 47 is in a second position. In the second position, the bell crank 30 has pivoted relative to both the attachment bracket 20 and the linkage 64, such that the bell crank has pivoted in a clockwise direction about the axis A. In the second position, the linkage 64 has also moved outwardly, in the direction of the arrow 84, a maximum distance from the attachment bracket 20 (upwardly and to the left when viewing FIG. 7). The headrest assembly frame 46 has also moved outwardly a maximum distance in the direction of the arrow 84. In the forward folded position, the headrest assembly frame 46 has also moved a maximum distance from the attachment bracket 20 (to the left when viewing FIG. 7), such that the second end 52 of the headrest assembly frame 46 is at the maximum distance D3.

In the illustrated embodiment the headrest bracket 48 is fixed relative to the headrest assembly frame 46. It will be understood that the headrest bracket 48 may be movably attached to the headrest assembly frame 46, such as in a known telescoping arrangement (not shown)

The principle and mode of operation of the vehicle seat frame assembly have been described in its preferred embodiment. However, it should be noted that the vehicle seat frame assembly described herein may be practiced otherwise than as specifically illustrated and described without departing from its scope.

What is claimed is:

1. A vehicle seat frame assembly comprising:
a seat bottom frame;
a seat back frame pivotally mounted relative to the seat bottom frame; and
a headrest assembly having a headrest, the headrest assembly movable between an extended position and a retracted position relative to the seat back frame;
wherein the headrest assembly is pivotally connected to the one of the seat bottom frame and a portion of the vehicle, and slidingly connected to the seat back frame.

2. The seat frame assembly according to claim 1, wherein when the seat back frame is in an upright position, the headrest assembly is in the extended position; and wherein when the seat back frame is in a forward folded position, the headrest assembly is in the retracted position.

3. The seat frame assembly according to claim 2, wherein the attachment bracket is attached to the seat frame rearward of point where the seat back frame pivots relative to the seat bottom frame.

4. The seat frame assembly according to claim 2, further including a bell crank.

5. The seat frame assembly according to claim 4, wherein the bell crank is pivotally attached to the attachment bracket.

6. seat frame assembly according to claim 5, further including a linkage.

7. The seat frame assembly according to claim 6, wherein the bell crank is pivotally attached to the linkage at a first pivot axis.

8. The seat frame assembly according to claim 7, wherein the headrest assembly is pivotally attached to the linkage at a second pivot axis.

9. The seat frame assembly according to claim 8, wherein the headrest assembly is slidingly mounted to the seat back frame.

10. The seat frame assembly according to claim 1, further including an attachment bracket attached to one of the seat bottom frame and the portion of the vehicle;
wherein the headrest assembly is pivotally connected to the attachment bracket.

11. The seat frame assembly according to claim 10, wherein the headrest assembly is movable between the extended position when the seat back frame is in the upright position and the retracted position when the seat back frame is in the forward folded position; and
wherein movement of the seat back frame from the upright position to the forward folded position causes the headrest assembly to slide relative to the seat back frame, thereby causing the headrest to move toward the seat back frame.

12. The seat frame assembly according to claim 11, wherein movement of the seat back frame from the forward folded position to the upright position causes the headrest assembly to slide relative to the seat back frame, thereby causing the headrest to move away from the seat back frame.

13. A headrest assembly for use in a vehicle seat in a vehicle, the vehicle seat having a seat back pivotally mounted relative to a seat bottom, the headrest assembly having a headrest attached thereto;
wherein the headrest assembly is pivotally connected to a portion of the vehicle; and
wherein folding of the seat back relative to the seat bottom causes the headrest assembly to pivot relative to the seat bottom.

14. The headrest assembly according to claim 13, wherein folding of the seat back relative to the seat bottom further causes the headrest assembly to slide relative to the seat back.

15. The headrest assembly according to claim 14, further including a bell crank.

16. The headrest assembly according to claim 15, wherein the bell crank is pivotally attached to one of the seat bottom and a portion of the vehicle.

17. The headrest assembly according to claim 16, further including a linkage.

18. The headrest assembly according to claim 17, wherein the bell crank is pivotally attached to the linkage at a first pivot axis.

19. The headrest assembly according to claim 18, wherein the headrest assembly is pivotally attached to the linkage at a second pivot axis.

20. A headrest assembly for use in a vehicle seat having a seat back pivotally mounted relative to a seat bottom, the headrest assembly having a headrest attached thereto, the headrest assembly comprising:
a bell crank pivotally attached to one of the seat bottom and a portion of the vehicle;
a headrest assembly frame; and
a linkage pivotally attached to the bell crank at a first pivot axis and pivotally attaché to the headrest assembly frame at a second pivot axis.

21. The headrest assembly according to claim 20, wherein the headrest assembly is slidingly mounted to the seat back of the vehicle seat.
